(19) United States
(12) Patent Application Publication
(10) Pub. No.: US 2004/0165885 A1
(43) Pub. Date: Aug. 26, 2004

(54) Method and apparatus for measuring the RF spectrum of an optical signal

(75) Inventor: Christophe J. Dorrer, Matawan, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/374,939

(22) Filed: Feb. 26, 2003

(51) Int. Cl. H04B 10/08

(52) U.S. Cl. 398/16

(57) ABSTRACT

A method and apparatus for measuring the RF spectrum of an optical signal under test includes combining an optical signal under test with a quasimonochromatic continuous signal to produce a combined signal, imparting a third order nonlinear effect on the combined signal such that a temporal intensity of the optical signal under test component of the combined signal modulates the electric field of the quasimonochromatic continuous signal component of the combined signal, and measuring the optical spectrum of the combined signal to determine the RF spectrum of the optical signal under test.

### FIELD OF THE INVENTION

This invention relates to the field of RF spectrum analyzers and, more specifically, to RF spectrum analyzers adapted for the characterization of optical sources.

### BACKGROUND OF THE INVENTION

The temporal characterization of light is important in a wide range of domains. For optical telecommunications, it may take several forms, such as the measurement of the electric field of a train of identical pulses, the statistical measurement of the intensity of a train of pulses (typically the eye diagram of a data-encoded train of pulses) or the measurement of correlation functions. Obtaining temporal information on an event requires an element with a response time on the order of the duration of the event. This bandwidth requirement is becoming increasingly difficult to meet with currently available electronics as the pulses that are used to carry information get shorter.

The power spectrum of the intensity (i.e., the modulus square of the Fourier transform of the intensity) is often referred to as the RF spectrum, although it extends well above the Radio Frequencies. The RF spectrum contains information about the temporal intensity of the source. The RF spectrum is widely used in many applications involving electronics (where the intensity is an electrical current) or optics (where the intensity is the usual temporal intensity of the light source under test). In optical telecommunications, the RF spectrum of a channel may be used for tracking impairments that degrade the temporal quality of a train of pulses, such as jitter, dispersion, polarization-mode dispersion or amplified spontaneous emission.

Conventional systems for the measurement of the RF spectrum of an optical source under test require high-bandwidth detectors and high frequency local oscillators, as well as various electronic components working at high frequencies. The bandwidth of such conventional systems is limited by the bandwidth of the detectors used and the availability of local oscillators at the appropriate frequencies. Utilizing currently available “off-the-shelf” components, the fastest photodetector-RF spectrum analyzers commercially available have a bandwidth lower than 100 Ghz. This bandwidth limitation hinders the usefulness of current spectrum analyzers in today's high speed/high capacity systems.

### SUMMARY OF THE INVENTION

The present invention advantageously provides a novel method and apparatus having a large bandwidth for measuring the RF spectrum of a light source under test based on third order optical nonlinearities.

In one embodiment of the present invention, a method for measuring the RF spectrum of an optical source under test includes combining an optical signal under test with a quasimonochromatic continuous signal to produce a combined signal, imparting a third order nonlinear effect on the combined signal such that the temporal intensity of the optical signal under test component of the combined signal modulates the electric field of the quasimonochromatic continuous signal component of the combined signal, and measuring the optical spectrum of the combined signal to determine the RF spectrum of the optical signal under test.

In an alternate embodiment of the present invention, an apparatus includes a quasimonochromatic continuous light source, and a nonlinear medium adapted to impart third order nonlinearities to optical signals passing therethrough, wherein the apparatus is adapted to combine an input signal under test with a signal from the quasimonochromatic continuous light source to produce a combined signal, and to propagate the combined signal along the nonlinear medium, the nonlinear medium imparting a third order nonlinear effect on the combined signal such that the temporal intensity of the optical signal under test component of the combined signal modulates the electric field of the quasimonochromatic continuous signal component of the combined signal. Alternatively, the apparatus further comprises a frequency resolving device for measuring the optical spectrum of the combined signal. The RF spectrum of the optical signal under test is thus determined by the frequency resolving device by measuring the optical spectrum of the combined signal proximate the spectral region of the frequency of the quasimonochromatic continuous signal.

In still another embodiment of the present invention, an apparatus includes a tunable quasimonochromatic continuous light source, and a nonlinear medium adapted to impart third order nonlinearities to optical signals passing therethrough, wherein the apparatus is adapted to combine an input signal under test with a signal from the tunable quasimonochromatic continuous light source to produce a combined signal, and to propagate the combined signal along the nonlinear medium, the nonlinear medium imparting a third order nonlinear effect on the combined signal such that the temporal intensity of the optical signal under test component of the combined signal modulates the electric field of the tunable quasimonochromatic continuous signal component of the combined signal. Alternatively, the apparatus further comprises an optical bandpass filter followed by a detector for measuring the power of the combined signal at the central frequency of the bandpass filter. The RF spectrum of the optical signal under test is thus determined by measuring the power of the combined signal at the central frequency of the bandpass filter while varying the optical frequency of the tunable quasimonochromatic light source.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for measuring the RF spectrum of an optical source under test including an embodiment of the present invention;

FIG. 2 graphically depicts an exemplary output spectrum of an RF spectrum analyzer in accordance with the present invention; and

FIG. 3 depicts a high level block diagram of a system for measuring the RF spectrum of an optical source under test including an alternate embodiment of the present invention.

To facilitate understanding, identical reference numerals have been used, where possible, to designate identical elements that are common to the figures.

### DETAILED DESCRIPTION OF THE INVENTION

Part of the invention resides in the inventor's recognition of the following principles. Specifically, the inventor realized that when using a conventional RF spectrum analyzer, such as a super-heterodyne RF spectrum analyzer, to characterize an optical source the bandwidth of such systems is substantially limited. In a conventional RF spectrum anayzer, an electrical current representative of the temporal intensity of the source under test is first generated using a photodetector with sufficient bandwidth for detecting the entire bandwidth of the source under test. This photocurrent is mixed with a tunable local oscillator. After mixing, the amplitude of the beating of the current with the tunable oscillator is filtered at an intermediate frequency and subsequently measured. The complete RF spectrum of the source is obtained by measuring the amplitude of the filtered beating as a function of the frequency of the local oscillator. The bandwidth of such conventional systems is limited by the bandwidth of the photodetector and the availability of local oscillators and mixers at appropriate frequencies. The inventor further realized that nonlinear optics on the other hand provide quasi-arbitrary bandwidth. With these principles recognized, the inventor provides a novel optical approach for measuring the power spectrum of the intensity of a light source (i.e., the RF spectrum).

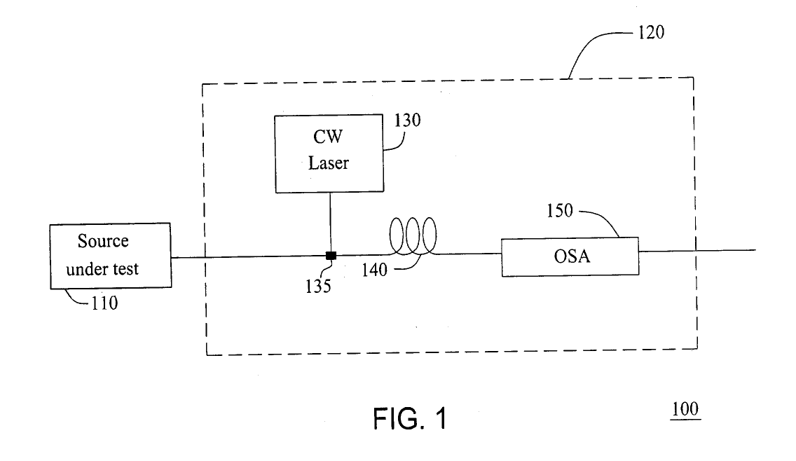

FIG. 1 depicts a high level block diagram of a system 100 for measuring the RF spectrum of an optical source under test including an embodiment of the present invention. The system 100 of FIG. 1 comprises an optical source under test 110 and a RF spectrum analyzer 120 in accordance with the present invention. The RF spectrum analyzer 120 comprises a quasimonochromatic continuous light source (illustratively a continuous laser) 130, a coupler 135, a nonlinear medium with a real (in the mathematical sense) third order nonlinearity (illustratively a highly nonlinear fiber span of length L with a nonlinear index n₂) 140, and a frequency resolving device (illustratively an optical spectrum analyzer (OSA)) 150.

Although in the system 100 of FIG. 1 the OSA 150 is illustratively depicted as being located within the RF spectrum analyzer 120, the OSA 150 may be located outside of the RF spectrum analyzer 120. Similarly, although the quasimonochromatic continuous light source 130 is depicted as being located within the RF spectrum analyzer 120, the quasimonochromatic continuous light source 130 may be located outside of the RF spectrum analyzer.

The formalism and equations for developing the concepts of the present invention assume a perfectly monochromatic source for the sake of simplicity, although perfectly monochromatic light sources do not exist. As such, the embodiments of the present invention illustratively comprise a quasimonchromatic light source (i.e. a source that has a bandwidth much smaller than its central wavelength, but the former not equal to zero). A continuous-wave monochromatic laser is considered a typical quasimonochromatic continuous light source. Using such a source does not change the results when implementing the present invention, even though the formalism and equations are developed assuming a perfectly monochromatic source.

The continuous laser 130 generates a monochromatic electric field at an optical frequency ω₀ characterized according to equation one (1) which follows:

E(t)=\sqrt{I₀} exp(iω₀t) (1)

wherein I₀ is the intensity of the continuous laser 130.

The optical frequency ω₀ of the continuous laser 130 is chosen outside of the spectral range of the optical source under test 110, which is centered at ω_{S}. The selected optical frequency for the continuous laser 130 is sufficiently separated from the spectral range of the optical source under test 110, such that the optical frequency ω₀ of the continuous laser 130 continues to remain outside of the spectral range of the optical source under test 110 after any broadening of the signal from the optical source under test 110 caused by the propagation of the signal from the optical source under test 110 along the nonlinear medium 140.

A signal from the optical source under test 110 is sent as an input to the RF spectrum analyzer 120. In the RF spectrum analyzer 120, the signal from the optical source under test 110 is combined with a signal from the continuous laser 130 by the coupler 135 to produce a combined signal. The combining of the signal from the optical source under test 110 and the signal from the continuous laser 130 in accordance with the present invention may be accomplished with conventional fiber couplers used in telecommunication applications, with a WDM coupler or with a polarizer. In free-space applications, a beam-splitter may also be used to couple a signal from the optical source under test with a signal from the quasimonochromatic continuous light source in an RF spectrum analyzer in accordance with the present invention.

Although the magnitude of the nonlinear polarization obtained when mixing electric fields is usually larger when the fields have the same linear state of polarization, the continuous laser 130 and the optical source under test 110 do not need to have the same linear state of polarization. In cases where an optical source under test and a quasimonochromatic continuous light source do not have substantially the same state of polarization, the effect of the nonlinear medium on propagating optical signals may depend on the relative states of polarization of the optical source under test and the quasimonochromatic continuous light source. Such dependence can be averaged, for example, by randomizing the polarization of the quasimonochromatic continuous light source at the input of an RF spectrum analyzer in accordance with the present invention, while measuring the optical spectrum of the combined signals at the output of the RF spectrum analyzer.

The combined signal (the signal from the optical source under test 110 and the signal from the continuous laser 130) is then propagated through the nonlinear medium 140. The nonlinear medium 140 imparts a third order nonlinear effect on the combined signal, such that the temporal intensity of the optical signal under test component of the combined signal modulates the electric field of the continuous laser signal component of the combined signal. Ensuring that the intensity of the signal from the optical source under test 110 is sufficient, the signal from the optical source under test 110 induces Cross-Phase Phase Modulation (XPM) (phase shift) in the signal from the continuous laser 130. As such, the electric field proximate the optical frequency ω₀ of the continuous laser 130 is modified according to equation two (2) which follows:

$${E}^{′} ( t ) = \sqrt{{I}_{0}} exp ( ⅈ {ω}_{0} t ) exp [ ⅈ \frac{2 {ω}_{0} {n}_{2} L}{c} I ( t ) ] = \sqrt{{I}_{0}} exp ( ⅈ {ω}_{0} t ) exp [ ⅈ β I ( t ) ] \qquad ( 2 )$$

with

$$β = \frac{2 {ω}_{0} {n}_{2}}{c}$$

when the optical source under test 110 and the continuous laser 130 have substantially the same state of polarization. It should be noted that the value of β depends on the respective states of polarization of the signals from the two sources 110, 130.

In equation 2 above, I₀ depicts the intensity of the signal from the continuous laser 130, I depicts the intensity of the signal from the optical source under test 110, β depicts the strength of the XPM in the nonlinear medium, n₂ is the nonlinear index of the nonlinear medium 140 (which itself is proportional to the real part of the third order nonlinearity of the nonlinear medium), L is the length of the nonlinear medium 140, and c is the speed of light. For a nonlinear phase shift induced by the signal from the optical source under test 110 on the signal from the continuous laser 130 that is relatively small (i.e., αLI(t)<<1), the exponential function in equation (2) is rewritten according to equation three (3) which follows:

exp[iβI(t)]=1+iβI(t) (3)

As such, the optical spectrum of the optical source under test 110 around the optical frequency ω₀ of the continuous laser 130 is then characterized according to equation four (4) which follows:

$$\begin{matrix}{\vert \int {E}^{′} ( t ) exp [ - ⅈ ω t ] ⅆ t \vert}^{2} = {I}_{0} [ δ ( ω - {ω}_{0} ) + \\ {β}^{2} {\vert \int ⅆ tI ( t ) exp [ ⅈ ( {ω}_{0} - ω ) t ] \vert}^{2} ] \\ = {I}_{0} [ δ ( ω - {ω}_{0} ) + {β}^{2} {\vert \tilde{I} ( ω - {ω}_{0} ) \vert}^{2} ]\end{matrix} \qquad ( 4 )$$

and is the sum of the input Dirac function at ω₀ and the RF spectrum of the optical source under test 110 centered around ω₀. Therefore, the OSA 150, or any frequency resolving device, by measuring the optical spectrum as a function of the optical frequency ω, leads to the measurement of the RF spectrum of the source under test 110 as a function of the frequency difference ω−ω₀. It should be noted that a frequency resolving device, such as the OSA 150, measures an optical spectrum as a function of the optical frequency ω. In the embodiment of the present invention of FIG. 1, the optical frequency of the continuous laser 130 is kept fixed at ω₀ while the optical spectrum of the combined signal is measured proximate (around) the frequency of the continuous laser 130.

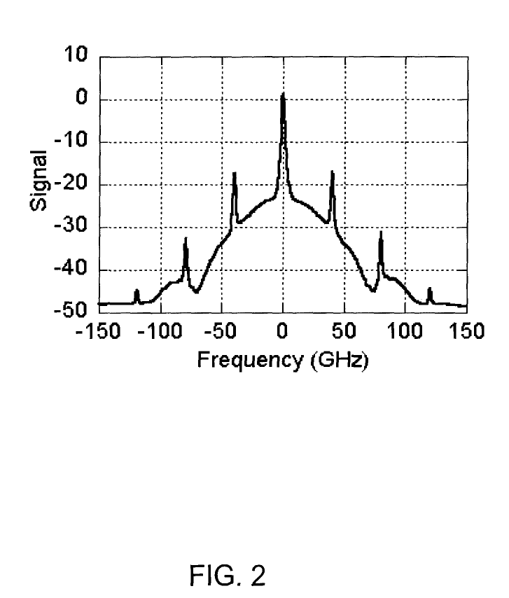

FIG. 2 graphically depicts an exemplary output spectrum of the RF spectrum analyzer 120 obtained for a source under test that is a 40 Gb/s data channel. The graph of FIG. 2 plots the signal intensity of the combined sources (on the vertical axis) versus the frequency of the continuous laser 130 (on the horizontal axis). The intensity axis in FIG. 2 ranges from -50 to 10 and the frequency axis ranges from −150 GHz to 150 GHz. The zero GHz frequency on the frequency axis corresponds to the optical frequency ω₀ of the continuous laser 130 (the quasimonochromatic continuous light source). To produce the graph of FIG. 2, the optical spectrum of the combined signal is measured proximate (around) the frequency of the continuous laser 130 and the optical frequency of the continuous laser 130 is kept fixed at ω₀. The RF spectrum of the source under test 110 is evident in FIG. 2, with components located at the zero frequency, at plus and minus 40 GHz, at plus and minus 80 GHz, and at plus and minus the 120 GHz frequencies.

In the embodiment described above with respect to FIG. 1, the bandwidth of the system 100 is primarily only limited by the OSA 150. It should be noted that the bandwidth of a system in accordance with the present invention may also be limited by the response time of the non-linear interaction and the group velocity mismatch between the waves at the frequency ω₀ of a quasimonochromatic continuous light source and the frequency ω₀ of an optical source under test in a nonlinear medium. Such bandwidth may be made extremely large in comparison to conventional electronic spectrum analyzers with a proper choice of a nonlinear medium (the interaction medium) and the frequency ω₀ of the quasimonochromatic continuous light source. For example, by choosing a nonlinear medium with a zero dispersion wavelength close to the wavelength of the optical source under test and the quasimonochromatic continuous light source, the bandwidth of the present invention may be made extremely large in comparison to conventional electronic spectrum analyzers. Furthermore, by choosing a quasimonochromatic continuous light source that has a group velocity at its central frequency ω₀ similar to the group velocity of the optical source under test at its central frequency ω_{S}, the bandwidth of a system may be made extremely large in comparison to conventional electronic spectrum analyzers.

In an alternate embodiment of the present invention, the nonlinear medium 140 of FIG. 1 is replaced with a two-photon absorption medium. There exist materials and structures that have band gaps greater than the energy corresponding to a particular incident radiation wavelength, such that photons of this wavelength are not absorbed at low power levels. At high intensities, however, the probability of simultaneously absorbing two photons greatly increases, and two photons together will have enough energy to carry an electron across the bandgap. Such physical phenomenon, known as two-photon photon absorption, is mathematically described by the imaginary part of the third order optical nonlinearity.

Consider, for example, an Indium Phosphide waveguide that has been configured to have a bandgap equal to 1.3 microns. At low intensity levels, the material will be transparent for wavelengths of 1.3 μm or greater (and therefore at 1.5 micron), but at high intensities, the material will be absorbing (via two-photon absorption) at 1.5 microns. Although Indium-Phosphide (InP) waveguides seem appropriate for the implementation of this embodiment to characterize light at 1.5 micron, other materials and structures may be used within the principles of the present invention. Other materials and structures may also be used when characterizing sources in a different wavelength range. The principles of two-photon absorption are well known to those skilled in the relevant art and will not be described in further detail herein.

The two-photon absorption medium embodiment comprises an optical source under test, and a RF spectrum analyzer in accordance with the present invention. The RF spectrum analyzer comprises a continuous quasimonochromatic continuous light source (e.g., a continuous laser), a coupler, a two-photon absorption medium, and a frequency resolving device (e.g., an optical spectrum analyzer (OSA)).

A signal from the optical source under test is sent as an input to the RF spectrum analyzer. In the RF spectrum analyzer, the signal from the optical source under test is combined with a signal from the quasimonochromatic continuous light source by the coupler to produce a combined signal. The combining of the signal from the optical source under test and the signal from the quasimonochromatic continuous light source may be accomplished with conventional fiber couplers used in telecommunication applications, with a WDM coupler or with a polarizer. In free-space applications, a beam-splitter may also be used to couple a signal from the optical source under test with a signal from the quasimonochromatic continuous light source in an RF spectrum analyzer in accordance with the present invention.

The quasimonochromatic continuous light source generates a monochromatic electric field at an optical frequency ω₀. As in the embodiment of the present invention of FIG. 1, the optical frequency ω₀ of the quasimonochromatic continuous light source is chosen outside of the spectral range of the optical source under test, which is centered at ω_{S}. Two-photon absorption also modulates the signal from the optical spectrum of the source under test and may cause the output spectrum to be broader than the input spectrum. As such, the selected optical frequency for the quasimonochromatic continuous light source is sufficiently separated from the spectral range of the optical source under test, such that the optical frequency ω of the quasimonochromatic continuous light source continues to remain outside of the spectral range of the optical source under test after any broadening of the signal from the optical source under test caused by propagation of the signal from the optical source under test along the two-photon absorption medium.

The combined signal (the signal from the optical source under test and the signal from the quasimonochromatic continuous light source) is then propagated through the two-photon absorption medium. The two-photon absorption medium imparts a third order nonlinear effect on the combined signal, such that the temporal intensity of the optical signal under test component of the combined signal modulates the electric field of the quasimonochromatic continuous light source signal component of the combined signal. The nonlinear contribution to the dielectric constant is proportional to the product of the temporal intensity of the optical source under test and the third order nonlinear susceptibility. This induces a temporal variation of the electric field of the quasimonochromatic continuous light source that is characterized according to equation five (5) which follows:

E′(t)=\sqrt{I₀} exp(iω₀t)exp [(α)I(t) (5)

wherein I₀ depicts the intensity of the quasimonochromatic continuous light source, I depicts the intensity of the source under test, and α depicts the strength of the two-photon absorption in the two-photon absorption medium, and is proportional to the length of the medium and the imaginary part of the third order nonlinear susceptibility.

In cases wherein the induced modulation is relatively small (i.e., (α)I(t)<<1), the exponential function in equation (5) is rewritten according to equation six (6) which follows:

exp[(α)I(t)]=1 +(α)I(t) (6)

As such, the optical spectrum of the electric field of the optical source under test around the optical frequency ω₀ of the quasimonochromatic continuous light source is then characterized according to equation seven (7) which follows:

$$\begin{matrix}{\vert \int {E}^{′} ( t ) exp [ - i ω t ] ⅆ t \vert}^{2} = {I}_{0} δ ( ω - {ω}_{0} ) + {I}_{0} ( {α}^{2} ) \\ {\vert \int I ( t ) exp [ - i ( ω - {ω}_{0} ) t ] ⅆ t \vert}^{2} \\ = {I}_{0} δ ( ω - {ω}_{0} ) + {I}_{0} ( {α}^{2} ) {\vert \tilde{I} ( ω - {ω}_{0} ) \vert}^{2}\end{matrix} \qquad ( 7 )$$

and is the sum of a Dirac function at ω₀ (i.e. the spectrum of the quasimonochromatic continuous light source) and the RF spectrum of the optical source under test under test centered around ω₀. Therefore, the frequency resolving device, by measuring the optical spectrum as a function of the optical frequency ω, leads to the measurement of the RF spectrum of the source under test as a function of the frequency difference ω−ω₀. It should be noted that a frequency resolving device measures an optical spectrum as a function of the optical frequency ω₀. In this embodiment of the present invention, the optical frequency of the quasimonochromatic continuous light source is kept fixed at ω₀ while the optical spectrum of the combined signal is measured proximate (around) the frequency of the quasimonochromatic continuous light source.

In still another embodiment of the present invention, the nonlinear medium 140 of FIG. 1 is replaced with a nonlinear medium wherein both, two-photon absorption and cross-phase modulation are imparted to propagating optical signals in the nonlinear medium. This is typically the case when the third order optical nonlinearity of the medium has both a real part (responsible for Cross-Phase Modulation) and an imaginary part (responsible for two-photon absorption). Similar to the embodiments described above, a signal from a source under test is combined with a signal from a quasimonochromatic continuous light source in the RF spectrum analyzer to produce a combined signal. The quasimonochromatic continuous light source generates a monochromatic electric field at an optical frequency ω₀. The optical frequency ω₀ of the quasimonochromatic continuous light source is again chosen outside of the spectral range of the optical source under test, which is centered at ω_{S}.

The combined signal (the signal from the optical source under test and the signal from the quasimonochromatic continuous light source) is then propagated through the nonlinear medium. The nonlinear medium imparts a third order nonlinear effect on the combined signal (i.e., in this case two-photon absorption and cross-phase modulation), such that the temporal intensity of the optical signal under test component of the combined signal modulates the electric field of the quasimonochromatic continuous light source signal component of the combined signal. This induces a temporal variation of the electric field of the continuous light source that is characterized according to equation eight (8) which follows:

E′(t)=\sqrt{I₀}exp(iω₀t)exp[(α+β)I(t)] (8)

wherein I₀ depicts the intensity of the continuous light source, I depicts the intensity of the optical source under test, α depicts the strength of the two-photon absorption nonlinear medium, and β describes the cross-phase modulation; these constants being respectively proportional to the imaginary and real part of the third order nonlinear susceptibility, and to the length of the medium.

In cases wherein the induced modulation is relatively small (i.e., (α+iβ)I(t)<<1), the exponential function in equation (8) is rewritten according to equation nine (9) which follows:

exp[(α+iβ)I(t)]=1+(α+iβ)I(t) (9)

As such, the optical spectrum of the electric field of the optical source under test around the optical frequency ω₀ of the quasimonochromatic continuous light source is then characterized according to equation ten (10) which follows:

$$\begin{matrix}{\vert \int {E}^{′} ( t ) exp [ - i ω t ] ⅆ t \vert}^{2} = {I}_{0} δ ( ω - {ω}_{0} ) + {I}_{0} ( {α}^{2} + {β}^{2} ) \\ {\vert \int I ( t ) exp [ - i ( ω - {ω}_{0} ) t ] ⅆ t \vert}^{2} \\ = {I}_{0} δ ( ω - {ω}_{0} ) + {I}_{0} ( {α}^{2} + {β}^{2} ) {\vert \tilde{I} ( ω - {ω}_{0} ) \vert}^{2}\end{matrix} \qquad ( 10 )$$

and is the sum of a Dirac function at ω₀ (i.e. the spectrum of the quasimonochromatic continuous light source) and the RF spectrum of the optical source under test centered around ω₀. As in the previous embodiments, the optical spectrum around the optical frequency of the quasimonochromatic continuous light source after modulation is representative of the RF spectrum of the optical source under test. Therefore, any frequency resolving device, by measuring the optical spectrum as a function of the optical frequency ω, leads to the measurement of the RF spectrum of the source under test as a function of the frequency difference ω−ω₀. It should be noted that a frequency resolving device measures an optical spectrum as a function of the optical frequency ω. In this embodiment of the present invention, the optical frequency of the quasimonochromatic continuous light source is kept fixed at ω₀ while the optical spectrum of the combined signal is measured proximate (around) the frequency of the quasimonochromatic continuous light source.

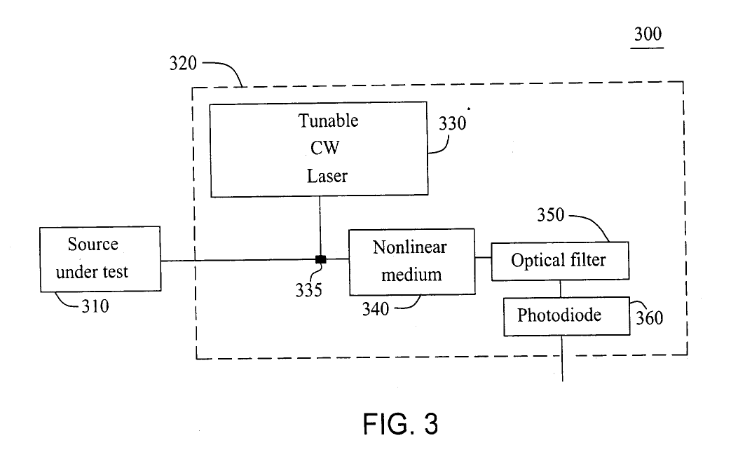

FIG. 3 depicts a high level block diagram of a system 300 for measuring the RF spectrum of an optical source under test including an alternate embodiment of the present invention. The system 300 of FIG. 3 comprises an optical source under test 310, and a RF spectrum analyzer 320 in accordance with the present invention. The RF spectrum analyzer 320 comprises a tunable quasimonochromatic light source (illustratively a tunable continuous laser) 330, a coupler 335, a nonlinear medium 340, and a fixed optical bandpass filter 350 followed by a detector (illustratively a photodiode) 360. The optical bandpass filter 350 is centered at an optical frequency ω_{F}. Such a filter may be, for example, a Fabry-Perot etalon filter. The functionality of the RF spectrum analyzer 320 is substantially similar to the embodiments of the invention described above except that the operation of frequency scanning is performed by the tunable laser 330 as explained below, whereas such operation was performed by the frequency resolving device in the previous embodiments. The nonlinear medium 340 is described as having both cross-phase modulation and two-photon absorption, although as in the previous embodiments, a device using a nonlinear medium with only cross-phase modulation or only two-photon absorption, would lead to substantially the same operation.

A signal from the optical source under test 310 is sent as an input to the RF spectrum analyzer 320. In the RF spectrum analyzer 320, the signal from the optical source under test 310 is combined with a signal from the tunable continuous laser 330 to form a combined signal. The tunable continuous laser 330 generates a monochromatic electric field at an optical frequency ω₀. As in the previous embodiments of the present invention described above, the optical frequency ω₀ of the tunable continuous laser 330 is chosen outside of the spectral range of the optical source under test 310, which is centered at ω_{S}.

In the RF spectrum analyzer 320, the combined signal (the signal from the optical source under test 310 and the signal from the tunable continuous laser 330) is then propagated through the nonlinear medium 340. The nonlinear medium 340 imparts a third order nonlinear effect on the combined signal such that the temporal intensity of the optical signal under test component of the combined signal modulates the electric field of the tunable continuous laser signal component of the combined signal. The optical spectrum around the optical frequency of the tunable continuous laser 330 is therefore described according to equation eleven (11), which follows:

I₀δ(ω−ω_{T})+I₀(α^{2+β}²)|Ĩ(ω−ω_{T})|². (11)

The combined signal is then filtered by the optical bandpass filter 350. The signal measured after the optical bandpass filter 350 by the photodiode 360 is therefore proportional to the quantity described according to equation twelve (12), which follows:

I₀δ(ω_{F}−ω_{T})+I₀(α²+β²)|Ĩ(ω_{F}−ω_{T})|². (12)

Such a signal is therefore representative of the RF spectrum of the source under test 310 measured at frequency ω_{F}−ω_{T}. Therefore, a complete measurement of the RF spectrum of the source under test 310 is obtained by measuring the signal from the photodiode 360 as a function of the frequency ω_{T} of the tunable laser 330. The scanning operation to get the complete measurement of the RF spectrum of the source under test 310 is therefore different from the one performed in the previous embodiments. However, such a device maintains the same advantages in terms of practical implementation and bandwidth as the previously described embodiments.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A method, comprising:
combining an optical signal under test with a quasimonochromatic continuous signal to produce a combined signal;
imparting a third order nonlinear effect on said combined signal such that a temporal intensity of the optical signal under test component of the combined signal modulates the electric field of the quasimonochromatic continuous signal component of the combined signal; and
measuring the optical spectrum of the combined signal to determine an RF spectrum of the optical signal under test.

2. The method of claim 1, wherein the RF spectrum of said optical signal under test is determined by measuring the optical spectrum of said combined signal proximate the spectral region of the frequency of said quasimonochromatic continuous signal.

3. The method of claim 1, wherein the RF spectrum of said optical signal under test is determined by measuring the power of said combined signal at a fixed optical frequency while varying the optical frequency of said quasimonochromatic continuous signal.

4. The method of claim 1, wherein said third order nonlinear effect comprises Cross Phase Modulation (XPM).

5. The method of claim 1, wherein said third order nonlinear effect comprises Two-Photon absorption.

6. The method of claim 1, wherein said third order nonlinear effect comprises both Cross Phase Modulation and Two-Photon absorption.

7. An apparatus, comprising:
a quasimonochromatic continuous light source; and
a nonlinear medium adapted to impart third order nonlinearities to optical signals passing therethrough;
wherein said apparatus is adapted to combine an input signal under test with a signal from said quasimonochromatic continuous light source to produce a combined signal, and to propagate said combined signal along the nonlinear medium, the nonlinear medium imparting a third order nonlinear effect on said combined signal such that a temporal intensity of the optical signal under test component of the combined signal modulates the electric field of the quasimonochromatic continuous signal component of the combined signal.

8. The apparatus of claim 7, further comprising a frequency resolving device for measuring the optical spectrum of the combined signal.

9. The apparatus of claim 8, wherein said frequency resolving device is an optical spectrum analyzer (OSA).

10. The apparatus of claim 8, wherein the RF spectrum of said optical signal under test is determined by said frequency resolving device by measuring the optical spectrum of said combined signal proximate the spectral region of the frequency of said quasimonochromatic continuous signal.

11. The apparatus of claim 7, wherein said quasimonochromatic continuous light source comprises a continuous laser.

12. The apparatus of claim 7, wherein said nonlinear medium is a nonlinear fiber and said third order nonlinear effect comprises Cross Phase Modulation (XPM).

13. The apparatus of claim 7, wherein said nonlinear medium comprises a two-photon absorption medium and said third order nonlinear effect comprises Two-Photon absorption.

14. The apparatus of claim 7, wherein said third order nonlinear effect comprises both Cross Phase Modulation and Two-Photon absorption.

15. An apparatus, comprising:
a tunable quasimonochromatic continuous light source; and
a nonlinear medium adapted to impart third order nonlinearities to optical signals passing therethrough;
wherein said apparatus is adapted to combine an input signal under test with a signal from said tunable quasimonochromatic continuous light source to produce a combined signal, and to propagate said combined signal along the nonlinear medium, the nonlinear medium imparting a third order nonlinear effect on said combined signal such that a temporal intensity of the optical signal under test component of the combined signal modulates the electric field of the tunable quasimonochromatic continuous signal component of the combined signal.

16. The apparatus of claim 15, further comprising an optical bandpass filter followed by a detector for measuring the power of said combined signal at the central frequency of the bandpass filter after said propagation.

17. The apparatus of claim 16, wherein the RF spectrum of said optical source under test is measured by measuring, after said propagating, the power of said combined signal at the central frequency of the bandpass filter while varying the optical frequency of said tunable quasimonochromatic continuous light source.

18. The apparatus of claim 15, wherein said nonlinear medium is a nonlinear fiber and said third order nonlinear effect comprises Cross Phase Modulation (XPM).

19. The apparatus of claim 15, wherein said nonlinear medium comprises a two-photon absorption medium and said third order nonlinear effect comprises Two-Photon absorption.

20. The appartus of claim 15, wherein said third order nonlinear effect comprises both Cross Phase Modulation and Two-Photon absorption.
